(19) United States
(12) Patent Application Publication
(10) Pub. No.: US 2014/0113497 A1
(43) Pub. Date: Apr. 24, 2014

(54) WATERPROOF CONNECTOR

(71) Applicant: ADVANCED CONNECTION TECHNOLOGY INC., New Taipei City (TW)

(72) Inventor: YUNG-SHENG WANG, NEW TAIPEI CITY (TW)

(73) Assignee: ADVANCED CONNECTION TECHNOLOGY INC., NEW TAIPEI CITY (TW)

(21) Appl. No.: 13/952,760

(22) Filed: Jul. 29, 2013

(30) Foreign Application Priority Data
Oct. 19, 2012 (TW) 101220272
Nov. 12, 2012 (TW) 101221856

(51) Int. Cl. H01R 13/52

(52) U.S. Cl. CPC H01R 13/52
USPC 439/660

(57) ABSTRACT

A waterproof connector has at least one terminal housing, at least one tongue shaped surface, at least one terminal set located in the terminal housing, a plurality of contact terminals located on a side of the tongue shaped surface, and a housing surrounding the terminal housing. A water seal frame is injection molded onto the housing. The water seal frame has a first area and a second area. The housing has a first surface and a second surface. The width of the first area is larger than that of the first surface. The width of the second area is smaller than that of the second surface. The first surface is located between the first area and the second area. The first surface is located between the first area and the second area, the second surface coincides with the second area.

### CROSS-REFERENCE TO RELATED APPLICATIONS

This non-provisional application claims priority under 35 U.S.C. § H 9(a) on Patent Application No(s). 101220272 filed in Taiwan, R.O.C. on Oct. 19, 2012, and Application No(s). 101221856 filed in Taiwan, R.O.C. on Nov. 12, 2012, the entire contents of which are hereby incorporated by reference.

### BACKGROUND OF THE INVENTION

1. Field of the Invention

The present invention is related to connectors, in particular, a waterproof connector having a water seal frame injection molded onto the housing.

2. Description of the Related Art

Ordinary electronic connecting devices are prone to water and moisture leakage. Water can enter into the circuitry via the housing of a connector, thereby causing short circuit and damages to the circuit components. The most common remedy to this problem is to add a water seal ring at the front end of a connector to seal the space between the connector and the holes on the housing of an electronic device, and thereby preventing water leakage entering the circuitry. However, the housing of a connector usually contains several holes. Therefore, some amount of water can still enter the circuitry by first entering the front opening of the connector housing, and then leaking through the holes of the connector housing.

### SUMMARY OF THE INVENTION

In order to solve the known problem of the connectors, the present invention provides a water seal frame which surrounds the housing via injection molding. The present invention can effectively seal the holes on the housing of a connector, and thereby preventing water from entering into the circuitry, and therefore realizing waterproof connectors.

According to the an embodiment of the present invention, a waterproof connector comprises: a terminal housing comprising a tongue shaped surface, the tongue shaped surface comprising a first side and a second side; a first terminal set located in the terminal housing, the first terminal set comprising a plurality of first contact terminals located on the first side of the tongue shaped surface; a housing surrounding the terminal housing; a water seal frame located on the housing and provided on the housing via injection molding, the water seal frame comprising: a first area having a width larger than the width of the first surface; and a second area having a width smaller than the width of the second surface. The second area forms a receiving socket. The first surface is located between the first area and the second area.

According to another embodiment of the present invention, a waterproof connector comprises: a terminal housing comprising a tongue shaped surface, the tongue shaped surface comprising a first side and a second side; a first terminal set located in the terminal housing, the first terminal set comprising a plurality of first contact terminals located on the first side of the tongue shaped surface; a first housing surrounding the terminal housing, the first housing comprising a receiving frame opening and a plurality of coupling portions, the coupling portions being located on the outer surface of the first housing; a second housing surrounding the first housing, the second housing comprising a connecting frame opening and a plurality of recess portions, the width of the connecting frame opening being larger than the width of the receiving frame opening, the recess portions being located on the inner side of the second housing, and corresponding to the coupling portion, the recess portions surrounding the coupling portions; and a water seal frame located on the second housing and provided on the second housing via injection molding, the water seal frame comprising an outer frame opening which surrounds the receiving frame opening and the connecting frame opening, the width of the outer frame opening being larger than the width of the connecting frame opening.

According to yet another embodiment of the present invention, a waterproof connector comprises at least one terminal housing which comprises at least one tongue shaped surface; at least one terminal set located in the terminal housing, the terminal set comprising a plurality of contact terminals located on a side of the tongue shaped surface; a housing surrounding the terminal housing; a water seal frame located on the housing and provided on the housing via injection molding. The water seal frame comprising: a first area having a width larger than the width of the first surface; and a second area having a width smaller than the width of the second surface. The second area forms a receiving socket. The first surface is located between the first area and the second area.

### BRIEF DESCRIPTION OF THE DRAWINGS

FIG. 1 is an exploded view for the first embodiment in accordance with the present invention.

FIG. 2 is an exploded view for a half-assembled waterproof connector in accordance with the first embodiment of the present invention.

FIG. 3 is a rear schematic view for the waterproof connector in accordance with the first embodiment of the present invention.

FIG. 4 is a schematic view for the terminal housing and the housing in accordance with the first embodiment of the present invention.

FIG. 5 is a schematic view for the injection molded water seal frame in accordance with the first embodiment of the present invention.

FIG. 6 is a schematic view for the waterproof connector with a gasket assembled thereon in accordance with the first embodiment of the present invention.

FIG. 7 is a schematic exploded view for an alternative embodiment for the housing and the water seal frame in accordance with the first embodiment of the present invention.

FIG. 8 is a schematic view for the waterproof connector with an additional terminal set in accordance with the second embodiment of the present invention.

FIG. 9 is a front schematic view for the waterproof connector with a metal piece in accordance with the second embodiment of the present invention.

FIG. 10 is a schematic view for the third embodiment in accordance with the present invention.

FIG. 11 is a rear schematic exploded view for the third embodiment in accordance with the present invention.

FIG. 12 is a first schematic view for an embodiment of the soldering pins in accordance with the third embodiment of the present invention.

FIG. 13 is a second schematic view for an embodiment of the soldering pins in accordance with the third embodiment of the present invention.

FIG. 14 is a third schematic view for an embodiment of the soldering pins in accordance with the third embodiment of the present invention.

FIG. 15 is a schematic view for the backside of the assembly of the first housing and the second housing in accordance with the third embodiment of the present invention.

FIG. 16 is a rear schematic view for the water seal frame which surrounds the entire body of the connector in accordance with the third embodiment of the present invention.

FIG. 17 is an exploded view for the fourth embodiment in accordance with the present invention.

### DETAILED DESCRIPTION OF THE PREFERRED EMBODIMENTS

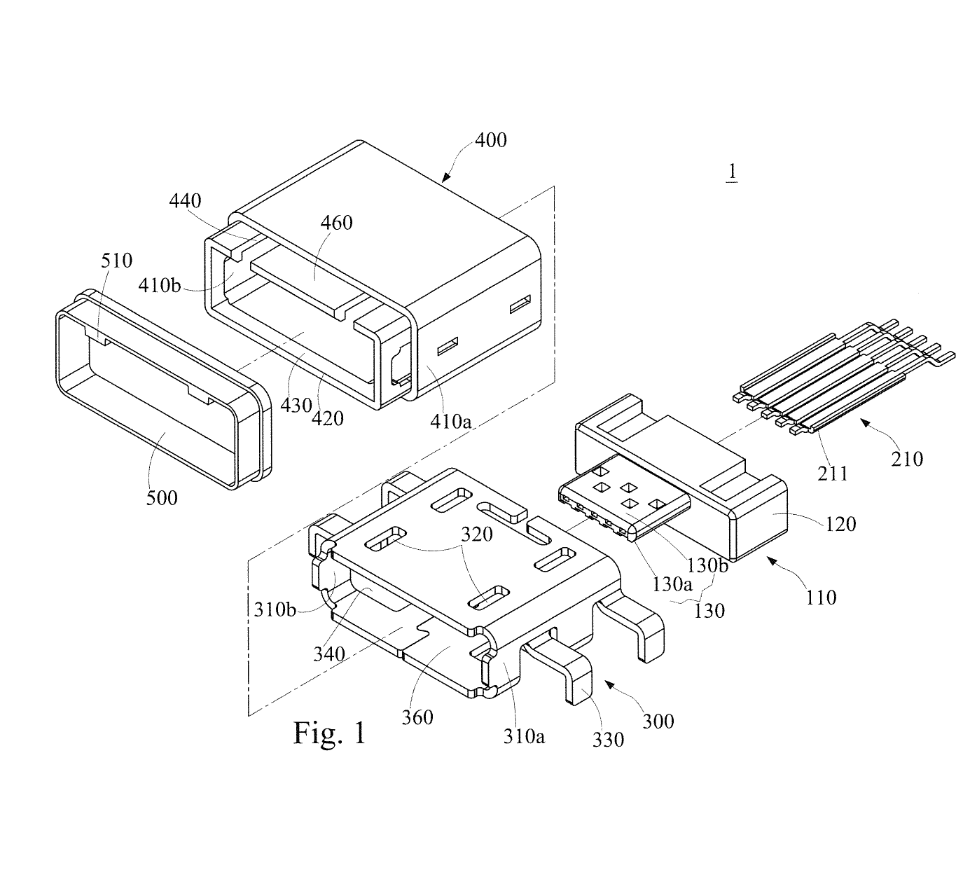

Please refer to FIG. 1 for an exploded schematic view for the first embodiment in accordance with the present invention. The waterproof connector 1 of the present embodiment comprises: a terminal housing 110, a first terminal set 210, a housing 300, and a water seal frame 400.

Referring to FIG. 1, the terminal housing 110 comprises a one-piece main body 120 and a tongue shaped surface 130. The tongue shaped surface 130 is formed by an extension of the main body 120, and comprises a first side 130a and a second side 130b.

Referring to FIG. 1 again, the first terminal set 210 is located in the terminal housing 110. The first terminal set 210 comprises a plurality of first contact terminals 211 located on the first side 130a of the tongue shaped surface 130. As being described here, the first side 130a is the lower side of the tongue shaped surface 130; however, the present invention is not intended to be limited to any particular configurations. In some embodiments, the first side 130a can be the upper side of the tongue shaped surface 130. In the present embodiment, the first terminal set 210 may be a Universal Serial Bus (USB).

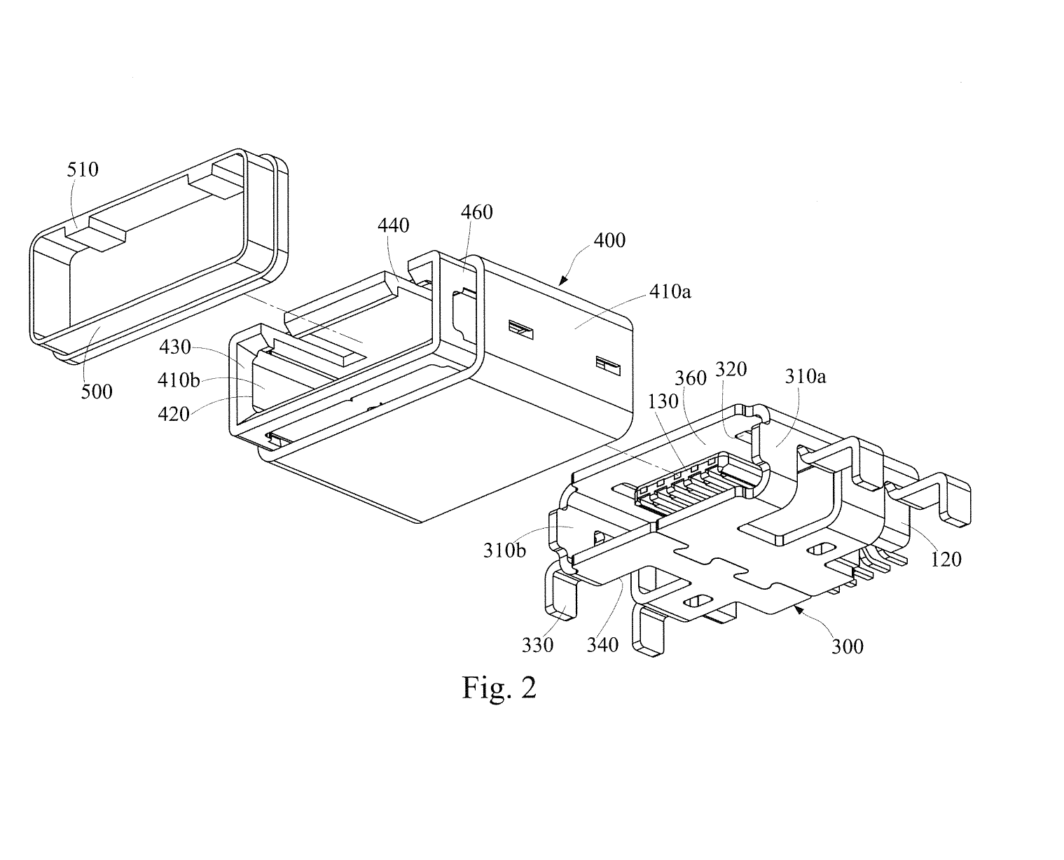

Referring to FIGS. 1 and 2, the housing 300 surrounds the terminal housing 110. The housing 300 comprises a receiving tunnel 360, a first surface 310a and a second surface 310b. The first surface 310a is the outer surface of the receiving tunnel 360 (namely, the outer wall of the receiving tunnel 360); and the second surface 310b is the inner surface of the receiving tunnel 360 (namely, the inner wall of the receiving tunnel 360). As being describe here, the housing 300 comprises a plurality of fixing holes 320, which are located between the first surface 310a and the second surface 310b. The fixing holes 320 provide fixing locations for foolproof elastic latches (not drawn in the figures) of a plug. In addition, the housing 300 comprises a plurality of soldering pins 330 extending from the first surface 310a of the housing 300; and in turn, the soldering pins 330 create a plurality of holes 340.

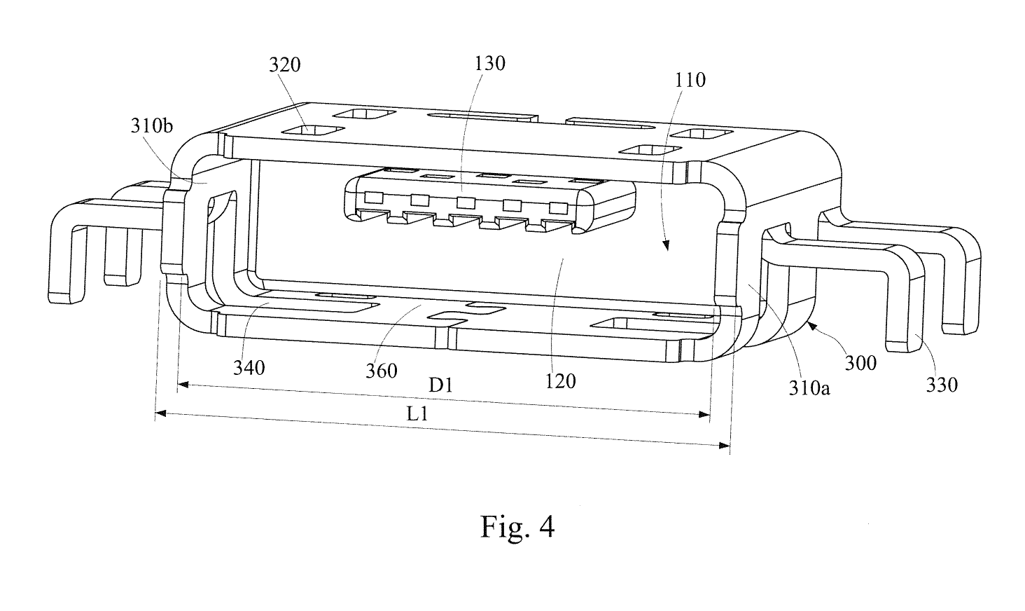

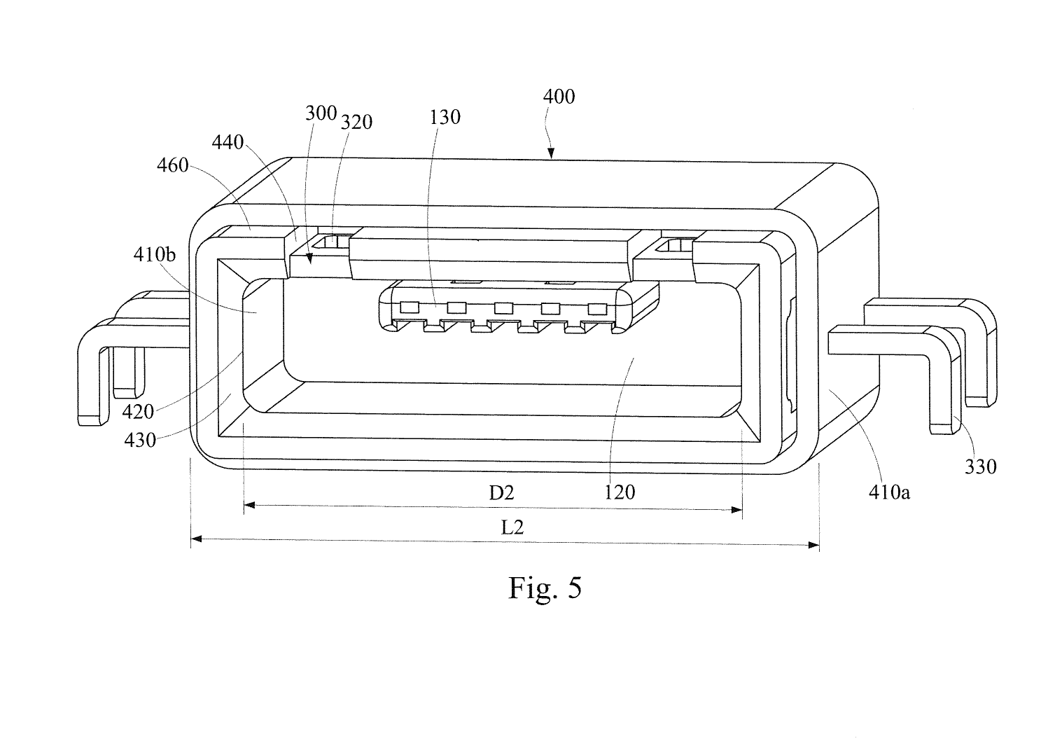

Referring to FIGS. 1 and 2 again, the water seal frame 400 is located on the housing 300, and is provided on the housing via injection molding. The water seal frame 400 comprises a first area 410a, and a second area 410b. The first area 410a is an outer area of the water seal frame 400; and the second area 410b is an inner area of the water seal frame 400. Referring to FIGS. 4 and 5, the width of the first area 410a is larger than that of the first surface 310a (that is, a distance L2 between two sides of the first area 410a is larger than a distance L1 between two sides of the first surface 310a). The width of the second area 410b is smaller than that of the second surface 310b (that is, a distance D2 between two sides of the second area 410b is smaller than a distance D1 between two sides of the second surface 310b). As shown in FIG. 5, the first surface 310a is located between the first area 410a and the second area 410b. In an embodiment, a side of the second surface 310b of the housing 300 may coincide with the second area 410b of the water seal frame (as shown in FIG. 5). In another word the second surface 310b and the second area 410b are in close contact. In a variation of the present embodiment, a side of the second surface 310b is partially or completely exposed by the second area 410b of the water seal frame 400 and provides mechanical support for the plugs.

The description which states that a side of the second surface 310b of the housing 300 is exposed by the second area 410b of the water seal frame is merely for demonstrative purpose. In another embodiment, at least one side of the second surface 310b can be exposed by the second area 410b.

Referring to FIGS. 4 and 5 again, the second area 410b forms a receiving socket 420 that matches an external plug (not shown in the figure). That is to say, the width D1 of the two sides of the second surface 310b of the housing is larger than the width of the plug. As being described here, the water seal frame 400 comprises a plurality of discharging holes 440 located on a step surface 460 which is provided at an opening of the water seal frame 400 and extends from the opening of the receiving socket 420. The discharging holes 440 are created by parts of the mold that cover the fixing holes 320 of the housing 300 during the injection molding process. The parts of the mold cover the fixing holes 320 (please refer to FIGS. 4 and 5) such that the fixing holes 320 cannot be filled during the formation of the water seal frame 400.

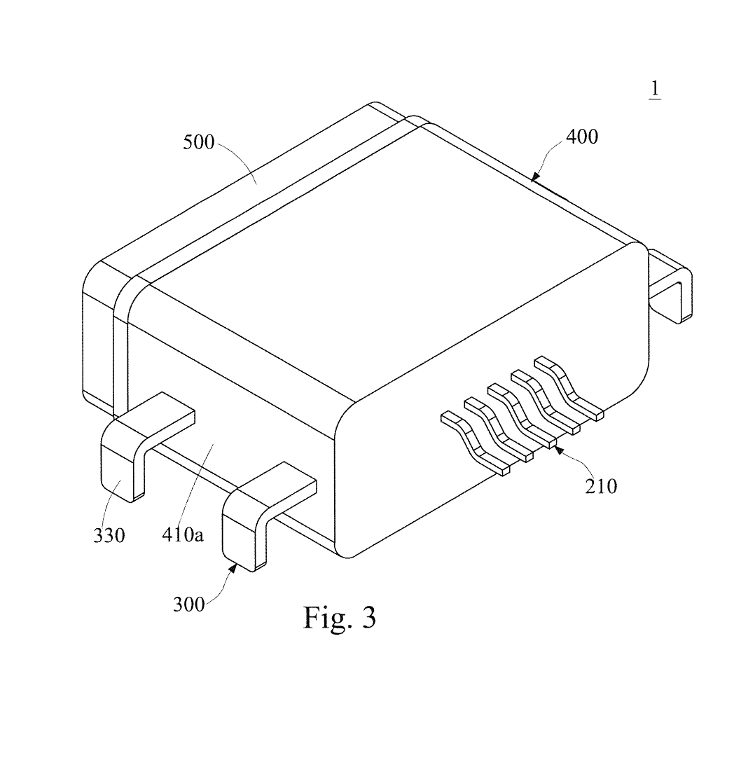

Referring to FIG. 3, the water seal frame 400 is located on the housing, and is provided on the housing via injection molding. The water seal frame 400 surrounds the housing 300, and only exposes the soldering pins 330 of the housing 300 and the soldering pins of the first terminal set 210, thus preventing water leakage.

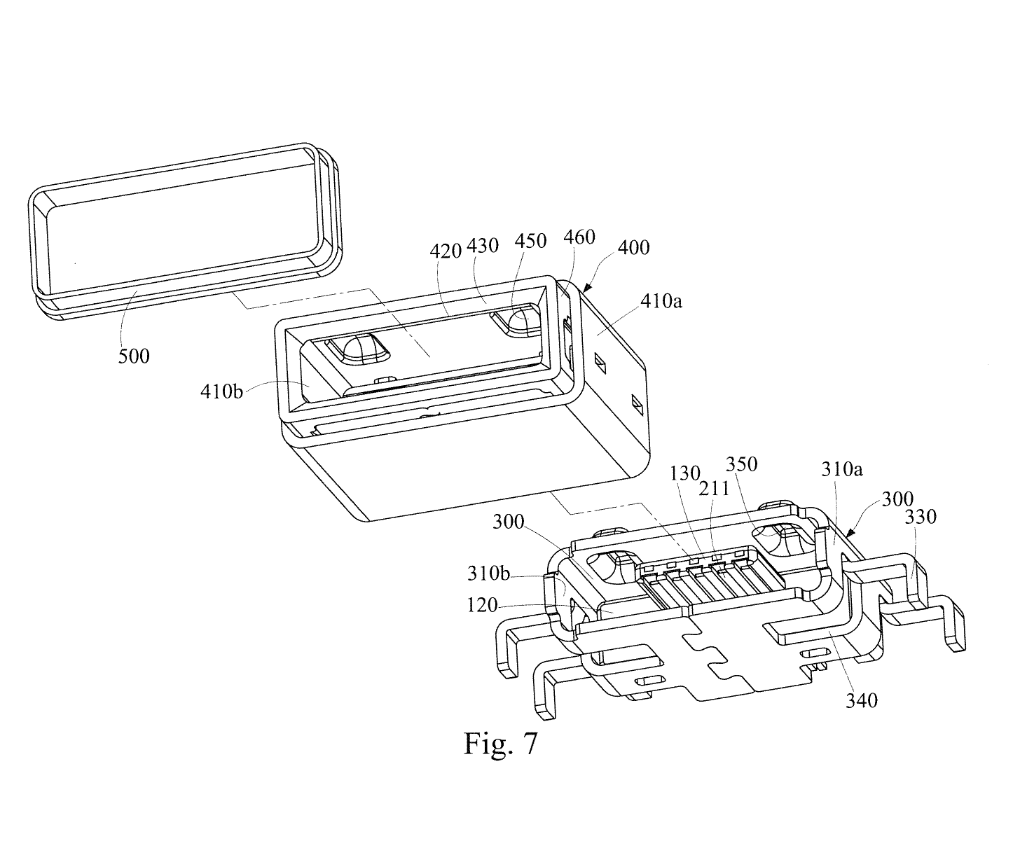

The description which states that the housing 300 comprises a plurality of fixing holes 320, and the water seal frame 400 comprises a plurality of discharging holes 440 is merely for demonstrative purpose. In another embodiment, the housing 300 may comprise a plurality of bumps 350 (as shown in FIG. 7); that is to say, the bumps 350 replace the fixing holes 320 that provide fixing locations for foolproof elastic latches. In addition, when the water seal frame 400 is injection molded on to the housing 300, the water seal frame 400 is affected by the geometry of the bumps 350, in turns, creating a plurality of recess portions 450 on the water seal frame 400.

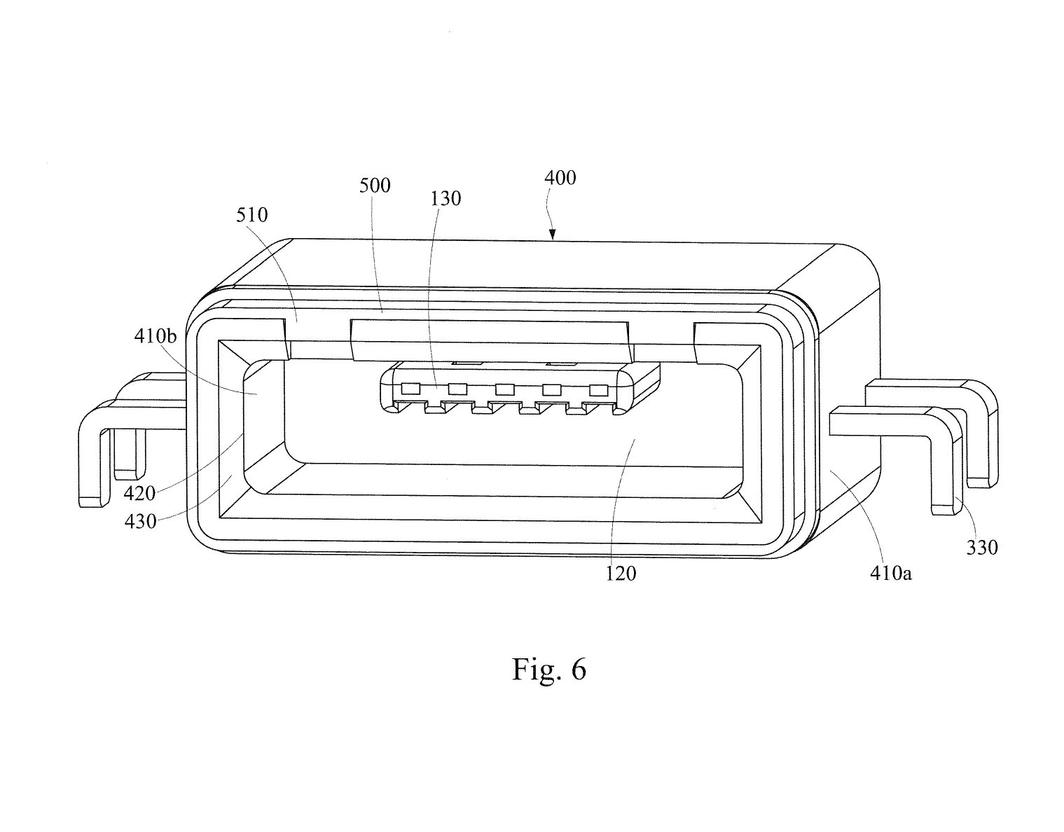

Please refer to FIGS. 1 and 2 again. In a variation of the present embodiment, the waterproof connector 1 may comprise a gasket 500. The step surface 460 provides fixation for the gasket 500. As been described here, the gasket 500 comprises a plurality of protrusions 510 which are able to be fitted into the discharging holes 440 of the water seal frame 400 (please also refer to FIGS. 5 and 6).

The description which states that the waterproof connector 1 comprises the gasket 500 is merely for demonstrative purpose. In other embodiments which the housing 300 is formed with a plurality of bumps 350, the water seal frame 400 may be formed in such way (as shown in FIG. 7) that the protrusions 510 of the gasket 500 are not required. As been shown in FIG. 7, the water seal frame 400 is formed with a continuous rectangular structure, omitting the step surface 460 structure.

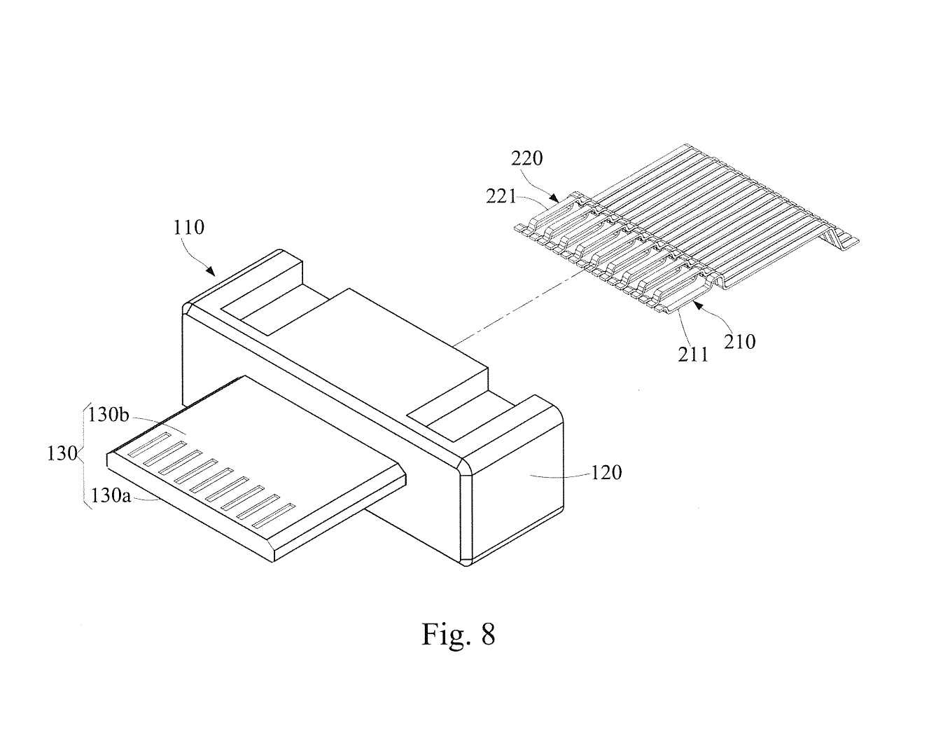

Referring to FIG. 8, in a second embodiment of the present invention, the waterproof connector 1 further comprises a second terminal set 220 located in the terminal housing 110. The second terminal set 220 comprises a plurality of second contact terminals 221 located on the second side 130b of the tongue shaped surface 130. In other variation of the embodiments, however, the second contact terminals 221 may also be located on the first side 130a of the tongue shaped surface 130. But here, for the purpose of demonstrating the present invention, the first terminal set 210 is provided on the first side 130a, and the second terminal set 220 is provided on the second side 130b. Notice that the number of the first terminal set 210 and the second terminal set 220 can be increased to fulfill the specifications of HDMI (High-Definition Multimedia Interface).

The description which states that the waterproof connector 1 further comprises a second terminal set 220 is merely for demonstrative purpose. In some embodiments, the waterproof connector 1 may further comprise more or less terminals, such that the waterproof connector 1 fulfills the specifications of ESATA, HDMI, display-port, Micro USB or other USB.

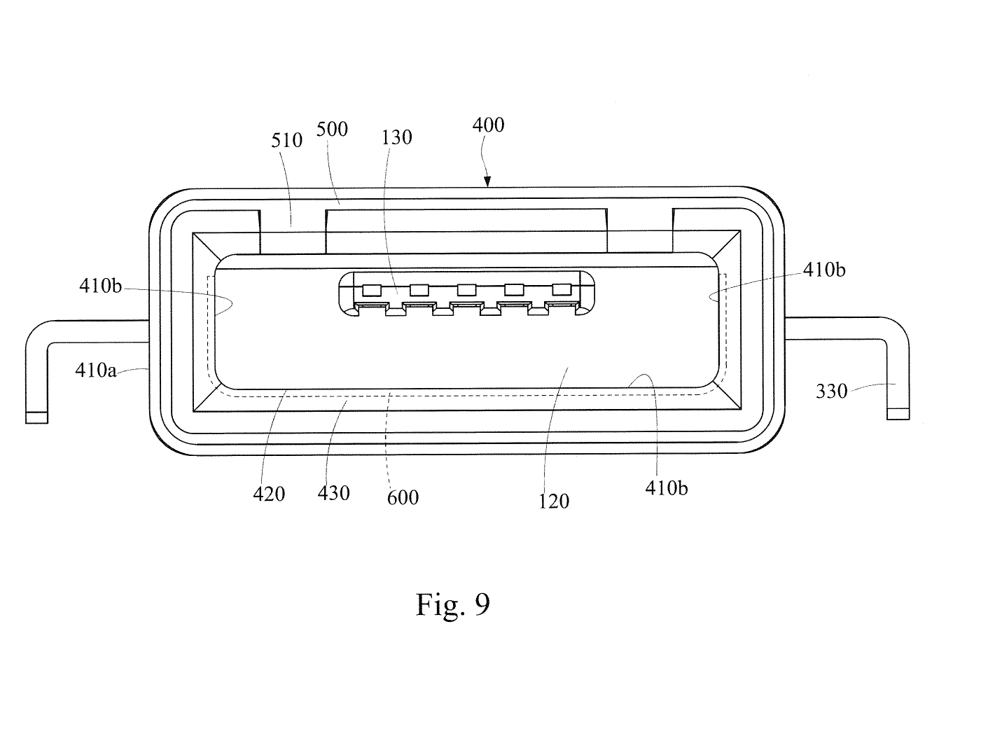

Referring to FIG. 9, in the second embodiment, the waterproof connector 1 may further comprise a metal piece 600 located on the second area 410b of the water seal frame 400. The width of the metal piece 600 is the same as the width of the second area 410b. That is to say, the metal piece 600 is a U-shaped structure, and the distance between the two opposing sides is the same as the distance between the two sides of the second area 410b. During a plug-in motion, the metal piece 600 is in contact with the plug, and prevents the water seal frame 400 from being worn out. In the present embodiment, the metal piece 600 is located on three sides of the second area 410b inside the water seal frame 400.

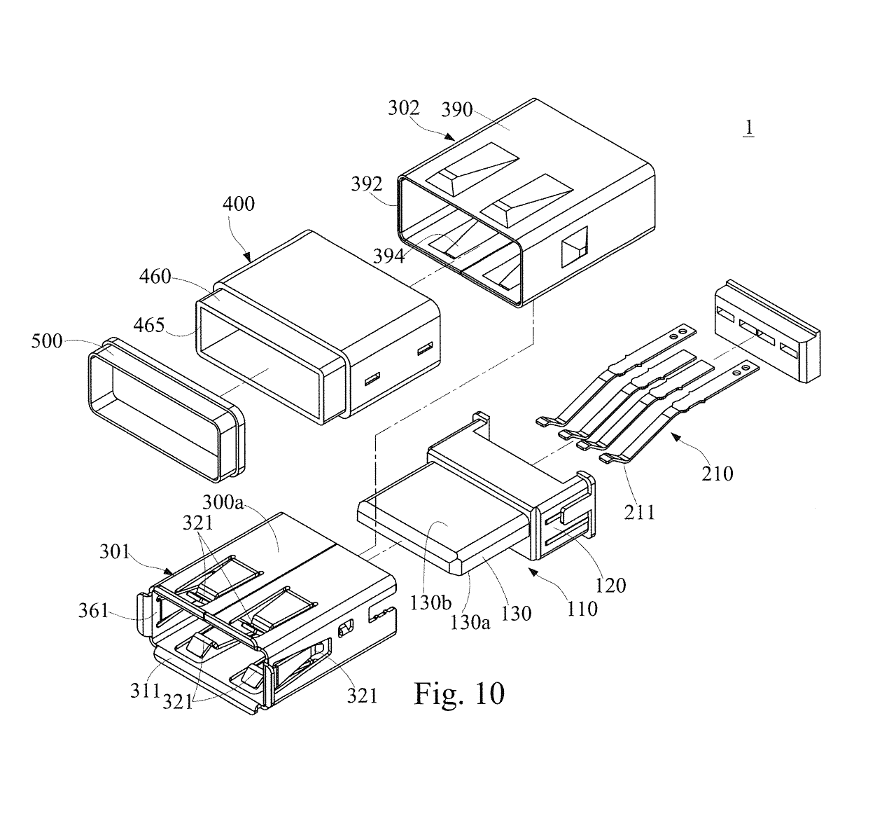

Please refer to FIG. 10 for an exploded schematic view for the third embodiment in accordance with the present invention. In this embodiment, the waterproof connector 1 may fulfill the USB specifications. The waterproof connector 1 of the present embodiment comprises: a terminal housing 110, a first terminal set 210, a first housing 301, a second housing 302 and a water seal frame 400. As shown in FIG. 10, the terminal housing 110 comprises a main body 120 and a tongue shaped surface 130; all of which are similar to those of the previous embodiment. The first terminal set 210 of the present embodiment is also similar to that of the previous embodiment, and meets the requirements of the USB specifications.

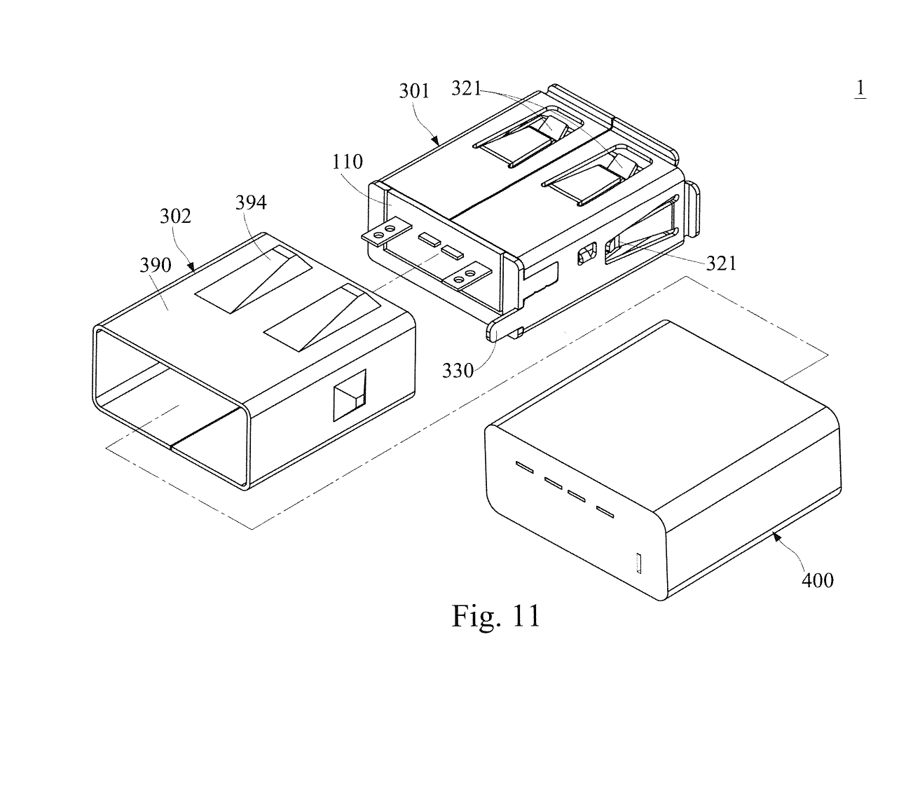

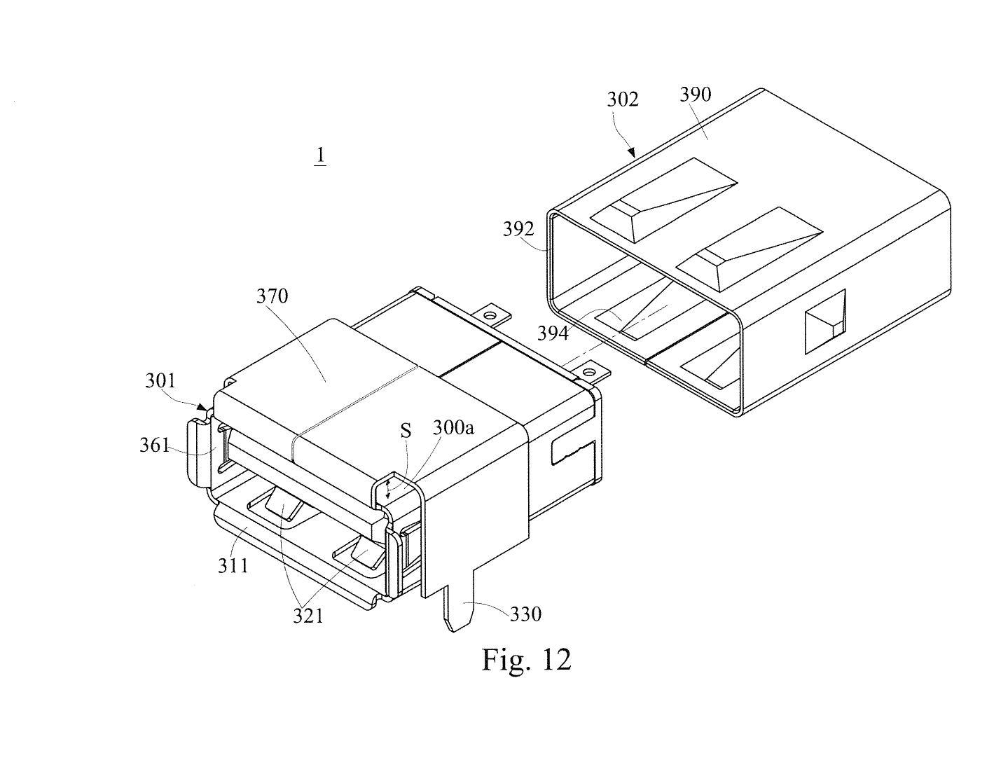

Referring to FIGS. 10 and 11, the first housing 301 surrounds the terminal housing 110. In the present embodiment, the first housing 301 is a rectangular frame structure. The first housing 301 comprises a receiving frame opening 361 and a plurality of coupling portions 321. The receiving frame opening 361 is located at an opening of the first housing 301 (which is the inserting area for plugs). In addition, the receiving frame opening 361 comprises a slant plane 311 which is located at the outer end of the receiving frame opening 361, for guiding the plug during a plugging-in motion. Furthermore, the coupling portions 321 are located at the sides of the first housing 301. According to the present embodiment, the coupling portions 321 are located on each side of the first housing 301 (as shown in FIG. 10). However, the present invention is not intended to be limited to this configuration. In the present embodiment, the coupling portions 321 are formed of elastic arms. The elastic arms extend toward the first housing 301 and provide fasten areas which couple to an inserting plug (not drawn in the figure). In addition, as shown in FIG. 12, the first housing 301 may comprise a plurality of soldering pins 330 and an extension portion 370 in another embodiment. The extension portion 370 is located at the outer surface of the first housing 301. The extension portion 370 extends from the receiving frame opening 361 and folds backward. The extension portion 370 is separated from the surface of the first housing 301 by a spacing S. That is, the second housing 302 is received in the spacing S. The soldering pins 330 are connected to the extension portion 370 at one end and to the circuit board (not drawn in the figure) at the other end.

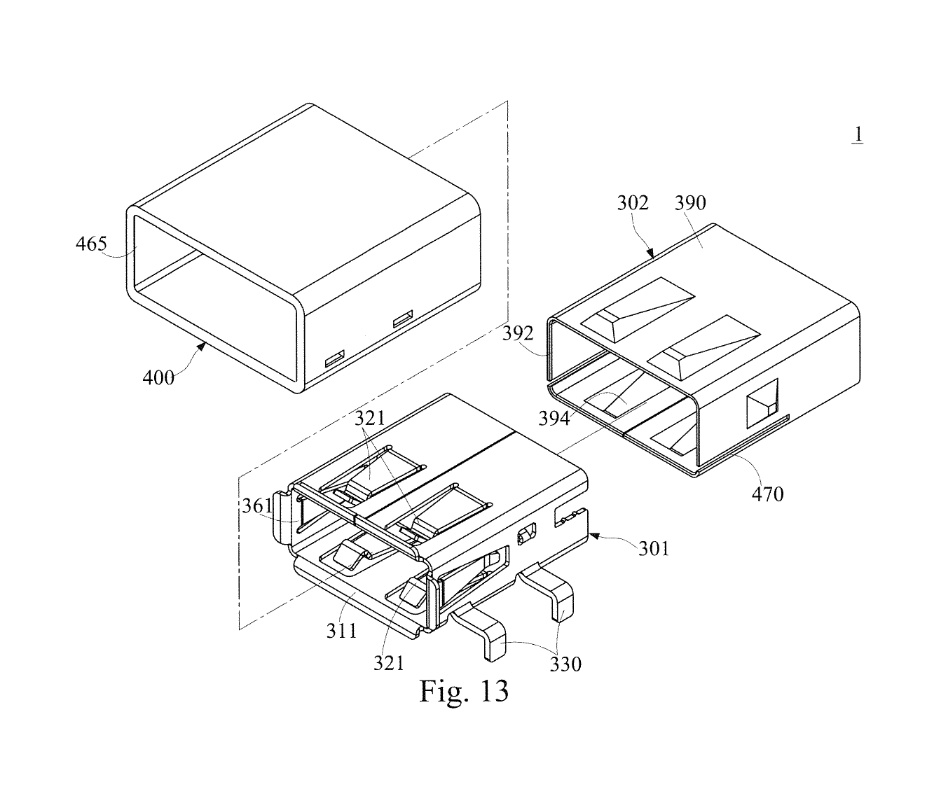

The foregoing description regarding the soldering pins 330 of the first housing 301 is merely for demonstrative purpose. In some embodiment, as shown in FIG. 13, the soldering pins 330 are located at two outer sides of the first housing 301. The second housing 302 may further comprise a plurality of corner slits 470. When the first housing 301 and the second housing 302 are coupled together, the soldering pins 330 are slid into the corner slits 470 and extend outward from the corner slits 470. In this manner, when the water seal frame 400 is injection molded onto the second housing 302, the corner slits 470 are surrounded by the water seal frame 400; and only the soldering pins 330 extend outside of the water seal frame 400.

In the present embodiment, the second housing 302 is a rectangular frame structure having a connecting frame opening 392 and a plurality of recess portions 394. The connecting frame opening 392 is at one end of the second housing 302. In addition, the width of the connecting frame opening 392 is larger than the width of the receiving frame opening 361. In the present embodiment, the recess portions 394 are located on the inner sides of the second housing 302. In addition, the positions of the recess portions 394 correspond to those of the coupling portions 321. The recess portions 394 surround the coupling portions 321. The recess portions 394 provide space for pivotal movement of the coupling portions 321; that is, when the waterproof connector 1 is connected with a plug, the coupling portions 321 are pressed by the plug and pivot into the recess portions 394.

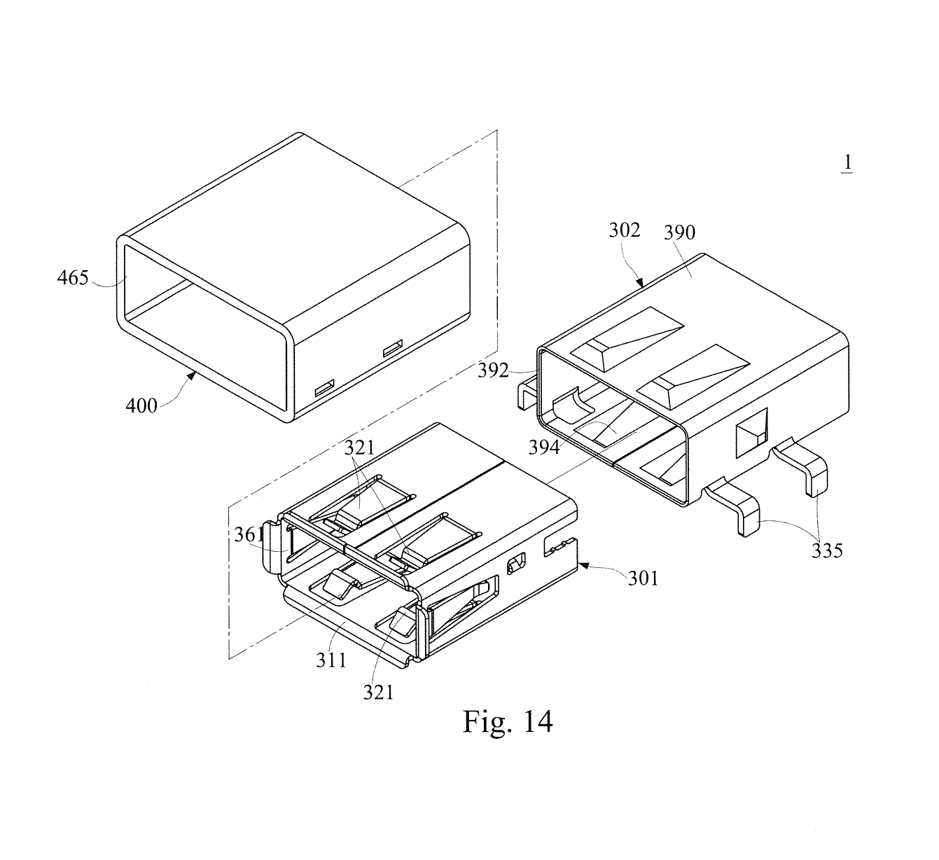

As shown in FIG. 14, the second housing 302 may comprise a plurality of soldering pins 335; therefore, the soldering pins 330 are no longer needed for the first housing 301 (as shown in FIG. 13). Therefore, when the water seal frame 400 is injection molded onto the second housing 302, the soldering pins 335 of the second housing 302 are exposed outside the water seal frame 400, for being soldered onto a circuit board (not shown in the figure).

Please refer to FIGS. 10 and 11 again. The water seal frame 400 described herein comprises an outer frame opening 465 located at one end of the water seal frame 400. The outer frame opening 465 surrounds the receiving frame opening 361 and the connecting frame opening 392. In the present embodiment, the width of the outer frame opening 465 is larger than that of the connecting frame opening 392.

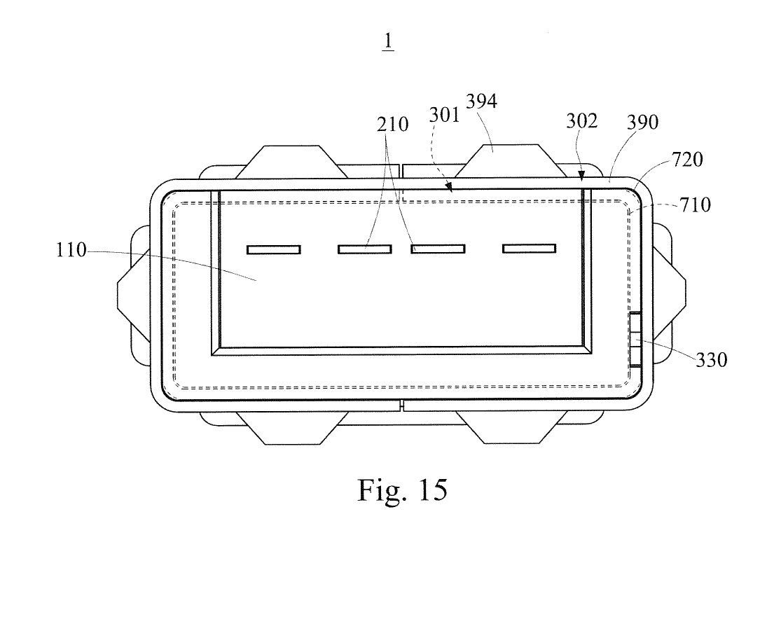

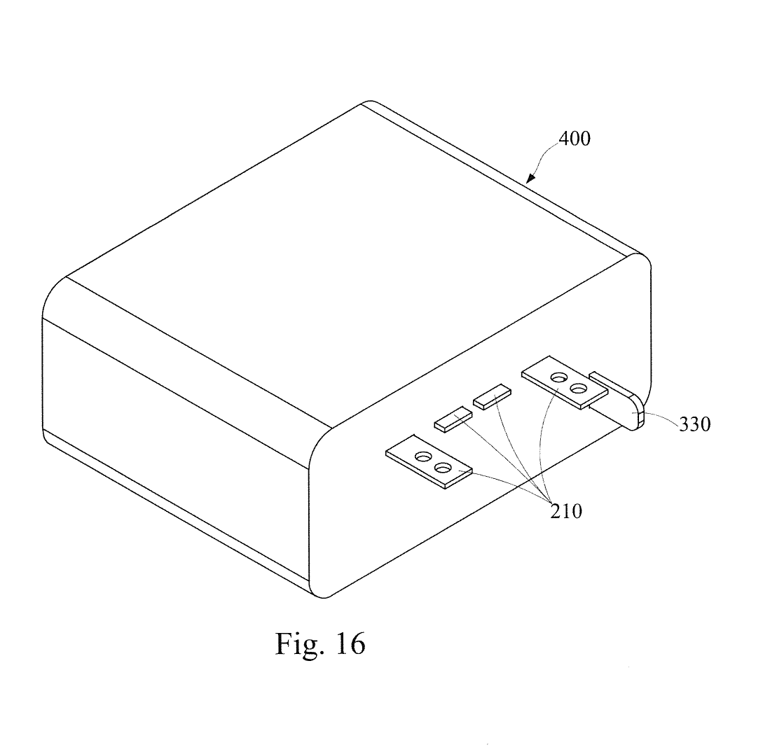

Please refer to FIGS. 15 and 16. FIG. 15 is a rear schematic view illustrating the assembly of the first housing and the second housing. FIG. 16 is a rear schematic view demonstrating that the water seal frame 400 surrounds the entire portion of a connector.

Note that the water seal frame 400 is not shown in FIG. 15. FIGS. 15 and 16 are intended to be view together. The water seal frame 400 surrounds the second housing 302; and only exposes the soldering pins 330 of the first housing 301 and the soldering pins of the first terminal set 210. This prevents water from leaking into the connector. The waterproof connector 1 in the present embodiment may further comprise a first slit 710 located between the terminal housing 110 and the first housing 301. When the water seal frame 400 is injection molded onto the second housing 302, the first slit 710 is filled. In addition, the waterproof connector 1 may further comprise a second slit 720 locating between the first housing 301 and the second housing 302. When the water seal frame 400 is injection molded onto the second housing 302, the second slit 720 is also filled.

Please refer to FIG. 10 and FIG. 11 again. In the present invention, the waterproof connector may further comprise a gasket 500. A step surface 460 is located at one end and extended outward from said end of the water seal frame 400, on which the gasket 500 is fixed.

The foregoing description which states that the waterproof connector 1 comprises the gasket 500 is merely for demonstrative purpose. In some embodiments, as shown in FIGS. 13 and 14, the step surface 460 may be omitted.

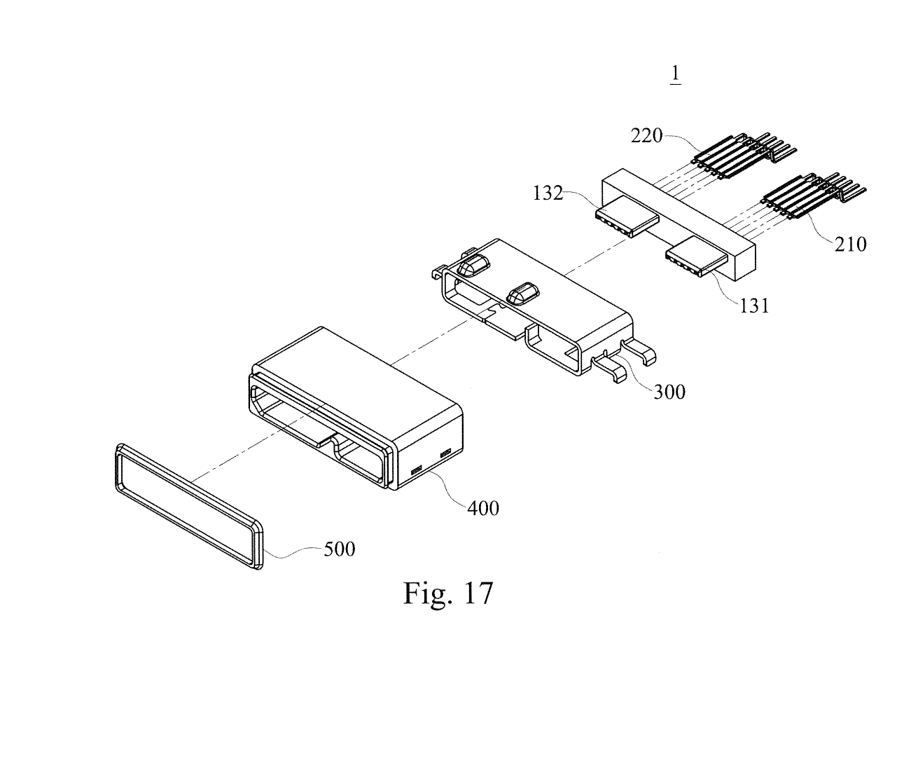

Please refer to FIG. 17 for an exploded schematic view for the fourth embodiment in accordance with the present invention. The waterproof connector 1 may comprise single or multiple terminal housing, tongue shaped surface and/or terminal set to meet the different connector specifications described above (i.e., ESATA, HDMI, display-port, Micro USB or other USB). By way of example, a waterproof connector 1 which fulfills the Micro USB 3.0 specifications is shown in FIG. 17. In the present embodiment, the waterproof connector comprises a terminal housing 110, two separate tongue shaped surfaces 131 and 132, and two separate terminal sets 210 and 220. A water seal frame 400 is located on the housing 300 and is provided on the housing 300 via injection molding. The structure of the water seal frame 400 in this embodiment is similar to those of FIG. 1-7 (the first embodiment). The major difference between the previous embodiment and the present embodiment is that the geometry of the water seal frame 400 is formed to suit the unique geometry of the Micro USB 3.0 housing; and in turn, the shape of the receiving socket also has a shape which corresponds to the shape of the Micro USB 3.0 plug.

The water seal frame, which is injection molded onto the housing, is used in the present invention to effectively prevent moisture leakage and protect the electronic components within a device. And thus the present invention advantageously provides a better solution to realize waterproof connector.

What is claimed is:

1. A waterproof connector, comprising:
a terminal housing comprising a tongue shaped surface, the tongue shaped surface comprising a first side and a second side;
a first terminal set located in the terminal housing, the first terminal set comprising a plurality of first contact terminals located on the first side of the tongue shaped surface;
a housing surrounding the terminal housing, the housing comprising:
a receiving tunnel;
a first surface located on the outer side of the receiving tunnel;
a second surface located on the inner side of the receiving tunnel;
a water seal frame located on the housing and provided on the housing via injection molding, the water seal frame comprising:
a first area, having a width larger than the width of the first surface; and
a second area, having a width smaller than the width of the second surface, the second area forming a receiving socket;
wherein the first surface is located between the first area and the second area, the second surface coincides with the second area.

2. The waterproof connector according to claim 1, further comprising a metal piece located on the second area of the water seal frame, wherein the width of the metal piece is equal to the width of the second area.

3. The waterproof connector according to claim 1, wherein the housing comprises a plurality of bumps, the water seal frame comprises a plurality of recess portions at the corresponding locations of the bumps.

4. The waterproof connector according to claim 1, wherein at least one side of the second surface of the housing is exposed by the second area of the water seal frame.

5. The waterproof connector according to claim 1, further comprising a step surface located between the first area and the second area of the water seal frame and near the outer surface of the receiving socket, wherein the step surface comprises a gasket.

6. The waterproof connector according to claim 1, further comprising a second terminal set located in the terminal housing, the second terminal set comprises a plurality of second contact terminals located on the first side or the second side of the tongue shaped surface.

7. A waterproof socket, comprising:
a terminal housing comprising a tongue shaped surface, the tongue shaped surface comprising a first side and a second side;
a first terminal set located in the terminal housing, the first terminal set comprising a plurality of first contact terminals located on the first side of the tongue shaped surface;
a first housing surrounding the terminal housing, the first housing comprising a receiving frame opening and a plurality of coupling portions, the coupling portions being located on the outer surface of the first housing;
a second housing surrounding the first housing, the second housing comprising a connecting frame opening and a plurality of recess portions, the width of the connecting frame opening being larger than the width of the receiving frame opening, the recess portions being located on the inner side of the second housing, and corresponding to the coupling portion, the recess portions surrounding the coupling portions; and
a water seal frame located on the second housing and provided on the second housing via injection molding, the water seal frame comprising an outer frame opening which surrounds the receiving frame opening and the connecting frame opening, the width of the outer frame opening being larger than the width of the connecting frame opening.

8. The waterproof socket according to claim 7, wherein the second housing is an outer frame structure of plastic or metal material.

9. The waterproof socket according to claim 7, further comprising a first slit located between the terminal housing and the first housing, wherein the water seal frame fills the first slit.

10. The waterproof socket according to claim 7, further comprising a second slit located between the first housing and the second housing, wherein the water seal frame fills the second slit.

11. The waterproof socket according to claim 7, wherein the first housing further comprising a plurality of soldering pins located on the outer surface of the first housing, the second housing further comprising a plurality of corner slits where the soldering pins are provided.

12. The waterproof socket according to claim 7, wherein the second housing further comprising a plurality of soldering pins located on the outer surface of the second housing.

13. The waterproof socket according to claim 7, wherein the first housing comprises a plurality of soldering pins and an extension portion, the extension portion is located on the outer surface of the first housing and comprises a spacing, the second housing is received in the spacing.

14. The waterproof socket according to claim 7, wherein the water seal frame further comprising a step surface located on the outer surface of the outer frame opening, the step surface comprises a gasket.

15. The waterproof socket according to claim 7 further comprising a second terminal set located on the terminal housing, the second terminal set comprises a plurality of second contact terminals located on the first side or the second side of the tongue shaped surface.

16. A waterproof connector, comprising:
at least one terminal housing which comprises at least one tongue shaped surface;
at least one terminal set located in the terminal housing, the terminal set comprising a plurality of contact terminals located on a side of the tongue shaped surface;
a housing surrounding the terminal housing, the housing comprising:
a receiving tunnel;
a first surface located on the outer side of the receiving tunnel; and
a second surface located on the inner side of the receiving tunnel;
a water seal frame located on the housing and provided on the housing via injection molding, the water seal frame comprising:
a first area, having a width larger than the width of the first surface; and
a second area, having a width smaller than the width of the second surface, the second area forming a receiving socket;
wherein the first surface is located between the first area and the second area, the second surface coincides with the second area.

17. The waterproof connector according to claim 16, further comprising a metal piece located on the second area of the water seal frame, wherein the width of the metal piece is equal to the width of the second area.

18. The waterproof connector according to claim 16, wherein the housing comprises a plurality of bumps, the water seal frame comprises a plurality of recess portions at the corresponding locations of the bumps.

19. The waterproof connector according to claim 16, wherein at least one side of the second surface of the housing is exposed by the second area of the water seal frame.

20. The waterproof connector according to claim 16, further comprising a step surface located between the first area and the second area of the water seal frame and near the outer surface of the receiving socket, wherein the step surface comprises a gasket.
